(19) United States
(12) Patent Application Publication
(10) Pub. No.: US 2009/0224570 A1
(43) Pub. Date: Sep. 10, 2009

(54) Low profile doble deck bus

(76) Inventors: Robert J. Haswell, Nixa, MI (US); Robert M. Haswell, Ozark, MI (US)

Correspondence Address: LATHROP & GAGE LLP, 1845 S. NATIONAL, P.O. BOX 4288, SPRINGFIELD, MO, 65808-4288, US

(21) Appl. No.: 12/381,254

(22) Filed: Mar. 10, 2009

Related U.S. Application Data
(60) Provisional application No. 61/068,730, filed on Mar. 10, 2008.

(51) Int. Cl. B62D 47/02

(52) U.S. Cl. 296/178

(57) ABSTRACT

A double deck bus having an overall height of twelve feet six inches or less configured to provide the maximum number of passenger seats and wherein the passenger aisle of the lower deck is offset the passenger aisle of the upper deck. The aisle of the upper deck is a channel which depends generally downward from the floor of the upper deck which allows at least seventy-five inches of clearance between the bottom of the upper aisle and the bus roof. The aisle of the lower deck is positioned along one side of the bus such that the upper aisle and lower aisle are offset thereby providing the maximum amount of head room for passengers traversing either aisle. Approximately eighty passenger seats can be provided in the bus due to this orientation without exceeding the preferred height, width or length restrictions which makes the bus acceptable for commuter purposes in and round large cities with tunnel and bridge size restrictions.

### RELATED APPLICATION

This Application claims the priority of the previously filed U.S. provisional application Ser. No. 61/068,730 filed on Mar. 10, 2008 and incorporates that application herein.

### FIELD OF INVENTION

The present invention relates to a novel double deck bus having the combined advantages of a low overall height and a capacity suitable for carrying a large number of passengers.

### BACKGROUND

While double deck buses have long been used abroad for general transportation purposes and, to a limited extent, within the United States for sightseeing within the tourism industry, there are no known double deck passenger buses suitable for carrying a large number of passengers in densely populated large cities. One of the primary limitations which has previously restricted the use of such a double deck bus are the height limitations for tunnels and bridges commonly found around large cities such as New York, Baltimore, and Massachusetts. Many tunnels and bridges have a maximum vehicle height limitation of twelve foot six inches which generally renders known double deck buses unusable.

It is the stated purpose of the inventive bus to operate as a commuter vehicle, shuttling passengers from remote locations into a city for work or other events. Currently, commuter services are somewhat limited with the inhabitants of small communities outlying large cities parking their personal vehicles on a lot and then either riding a train or taking a single deck passenger bus into the city. Commuting by trains is somewhat limited because the trains are obviously restricted to the rail system. While transport by bus works reasonably well, the number of passengers is restricted by overall bus size.

It is desirable to provide a double deck bus having a low enough profile to meet or exceed the height restrictions of tunnels and bridges while providing a high number of passenger accommodations for commuting. Passengers are often on buses or trains for periods of more than four hours a day, total commuting time. Accordingly, it is necessary for the vehicle to be comfortable and passenger friendly. In that regard, a bathroom with plentiful water is preferred. Large windows are provided to allow passengers to easily view landscape and surroundings.

Previously known double deck buses have generally exceeded the preferred total bus height of twelve feet six inches which is a common height restriction for vehicles using tunnels and bridges. Some effort to develop height limited double deck buses has been undertaken. Generally, such efforts have included decreasing the standing height on both the upper and lower decks which results in passenger inconvenience and discomfort. In U.S. Pat. No. 3,971,455 to Molzon, a double deck bus is described having aisles which are recessed generally downward on both decks with the upper aisle offset from the bottom aisle. The configuration of that bus, however, necessarily limits the number of passenger seats due to wide and meandering aisles. The configuration of the instant bus maximizes passenger seats, provides acceptable head and leg room for passengers and allows all but the tallest passengers to use the aisles without bending.

Finally, the high capacity, low profile double deck bus has a significant economic benefit to operators. Traditional commuter buses have approximately fifty to fifty-five passenger seats. By providing eighty total seats, the operator can generate additional revenue by increasing passenger loads while operating a single bus at standard operation costs with normal maintenance expenses. By adding twenty-five additional seats over a standard bus, an operator, assuming a charge of $20.00 per day for round trip commute, would bring in an additional $130,000.00 per year of operation. Accordingly, the novel bus described and claimed herein provides an economic benefit to its owner and operator.

### SUMMARY OF THE INVENTION

The present invention provides a double deck bus having an upper passenger deck and a lower passenger deck. It is preferred that the upper and lower decks each have at least seventy-five inch standing headroom for passengers. The overall height of the bus, however, must be twelve foot six inches (150 inches) or less to make it usable in and around large cities with clearance limited tunnels and bridges. To meet the twelve foot six inch overall height requirement and provide seventy-five inches of headroom in both the upper and lower deck, the aisle of the upper deck is offset from the aisle of the lower deck. Moreover, the upper deck aisle preferably forms a channel positioned between two spaced apart rows of passenger seats. The channel is centrally located between the seats along the length of the bus. The channel encroaches generally downward into the lower deck compartment about thirteen inches. It is to be understood that the bus could be constructed with a greater overall height than twelve and one half feet where height is not a concern. This allows more headroom for the lower, upper or both decks.

The lower deck is oriented so that a plurality of rows of passenger seats are positioned along one side of the bus leaving a passenger aisle adjacent the opposite side. This orientation, having the upper passenger aisle medially aligned and the lower aisle positioned along one sidewall of the bus provides the maximum passenger headroom clearance for passengers in both the upper and lower decks. The aisle in the lower deck is at least seventy-five inches high as is the distance between the bottom of the aisle in the upper deck and the bus top. Passengers in the upper deck step upward from the central aisle onto a platform onto which the seats are fastened.

The bus is preferably provided with one stairwell to maximize seating, however, two stairwells could be utilized with one adjacent the driver's box at the front of the bus and one oriented between the drive axle and steer axle of the bus. Multiple doors are generally provided. Three doors are preferable because of the high number of passengers that can ride at any given time, three doors allows sufficient loading and unloading of the vehicle. The aisle in the lower deck is preferably along the side of the bus into which the doors are positioned. This allows passengers utilizing the upper deck to enter a bus door, walk down the lower deck aisle and then access the stairwells without disturbing passengers already seated in the lower deck.

### BRIEF DESCRIPTION OF THE DRAWINGS

FIG. 1 is a partial side view of the bus.

FIG. 2 is a top plan view of the lower deck of the bus.

FIG. 3 is a top plan view of the upper deck of the bus.

FIG. 4 is a cross sectional view of the bus taken along line A-A of FIG. 1.

### DETAILED DESCRIPTION OF THE INVENTION

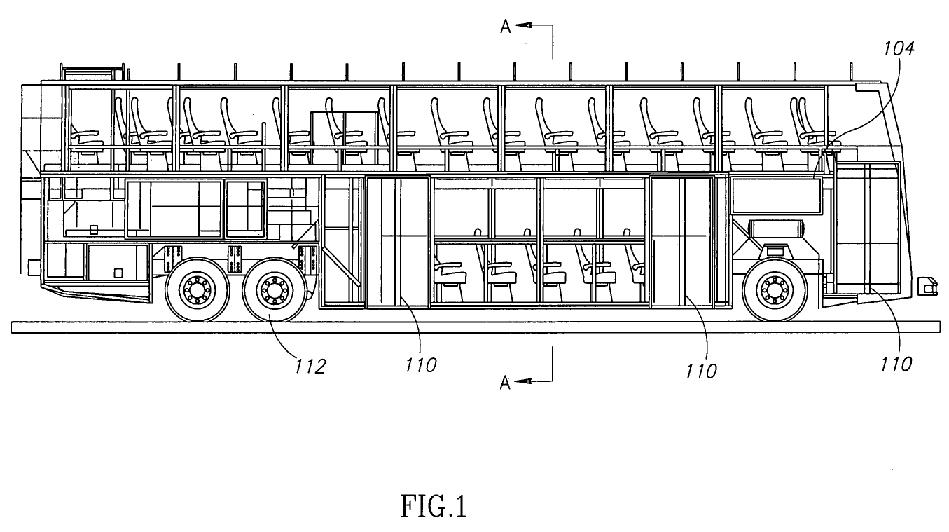

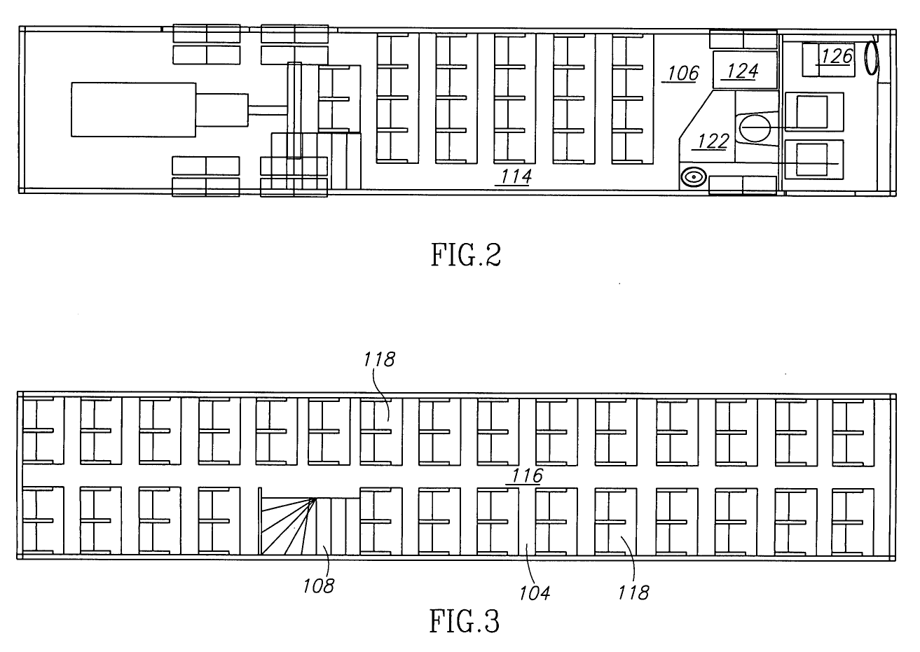

Referring now generally to the drawings, the preferred embodiment of the inventive bus is disclosed. As best seen in FIG. 1, a double deck bus is provided having an upper seating platform 104 and a lower seating platform 106. The maximum height of the bus from the ground is twelve foot six inches (150 inches) which allows the bus to navigate most height restricted tunnels and bridges in the United States. The bus is configured to provide the maximum number of comfortable seating platforms for the passengers. As seen in FIGS. 2 and 3, a total of eighty seats can be presented in the inventive bus without exceeding the maximum height, width and length dimensions. Some of the seats on the lower level can be folded or removed to provide additional space and additional wheel chair accommodations.

As shown in FIGS. 1 and 2, it is preferred that the stairwell 108 to the upper deck is positioned on the same side of the bus as the doors 110. One stairwell 108 is positioned adjacent to the rear drive axles 112. A second, or forward stairwell could be positioned at the front of the bus adjacent the driver's compartment. A third passenger access door 110 may be positioned between the forward and rear most passenger doors.

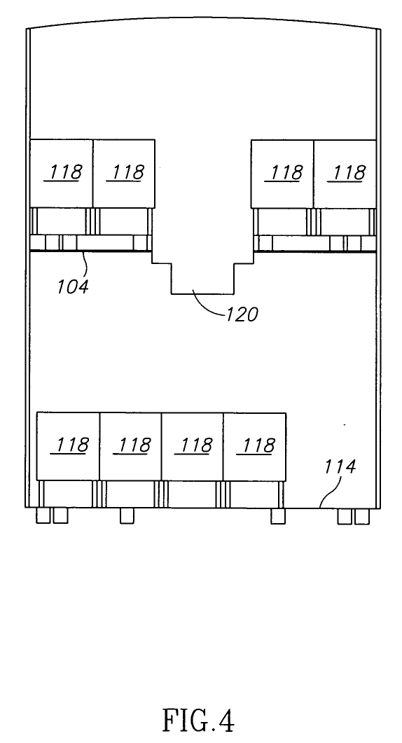

As shown in FIG. 2, a passenger aisle 114 at the lower deck is oriented along one side of the bus, generally adjacent the passenger access doors 110 and the rear stairwell 108. If present, the forward stairwell is not used to access the lower deck of the bus but is used solely for accessing the upper deck. As best seen in FIG. 3, a passenger aisle 116 of the upper deck 104 is centrally located with two passenger seats 118 provided on either side of the aisle 116. The aisle 116 itself, however, as shown in FIG. 4, is actually a channel 120 positioned several inches lower than the bottom of the upper passenger seat platforms 104. In the preferred embodiment, the channel 120 is approximately thirteen inches lower than the bottom of the seats 118 which provides seventy-five inches of passenger head room between the bottom of the aisle and the top of the bus. The aisle 114 of the lower deck is seventy-five inches below the upper deck 104 and is offset from the center aisle channel 120 of the upper deck 104. This allows sufficient aisle height for passengers to legally stand in the bus which can increase passenger capacity. The bus can be constructed with a greater overall height than twelve and one half feet where height is not a concern. This allows more headroom for the lower, upper or both decks.

Because the purpose of the bus is generally for commuting, it is necessary to provide a bathroom facility 122 which is best seen in FIG. 2. A water supply 124 is provided as is a water heater sufficient to meet the needs of eighty passengers over a period of several hours.

As also seen in FIG. 2, the driver's seat 126 is compartmentalized and separated from the passenger spaces. This provides security for the driver, aids in law enforcement for any wrongful activities by passengers.

While the present invention is described herein with reference to the embodiments illustrated for particular applications, it should be understood that the invention is not limited thereto. Those having ordinary skill in the art and access to the teachings provided herein will recognize additional modifications, applications, and embodiments within the scope thereof and additional fields in which the present invention would be of significant utility. It is therefore intended by the appended claims to cover any and all such modifications, applications and embodiments within the scope of the present invention.

What is claimed is:

1. A double deck bus having an overall height not exceeding twelve feet six inches, said bus comprising: a lower passenger deck having a plurality of passenger seats positioned against a wall of the bus and a passenger aisle between the seats and a second wall of the bus; an upper passenger deck extending the full length of the bus having a passenger aisle positioned substantially in the center of the bus and a plurality of passenger seats oriented on either side of the aisle and wherein the passenger aisle of the upper deck depends generally downward below the upper deck such that it invades the interior compartment of the lower deck and wherein the aisle of the upper deck is generally offset the passenger aisle of the lower deck to maximize the head room and clearance of passengers utilizing the aisles.

2. The double deck bus of claim 1 further comprising a separate driver's compartment.

3. The double deck bus of claim 1 further comprising a first staircase adjacent the forward portion of the passenger aisle and a second staircase spaced apart from the first staircase.

4. The double deck bus of claim 3 wherein the first staircase and second staircase are positioned on the same side of the bus.

5. The double deck bus of claim 1 further comprising a plurality of passenger seats which are removable to accommodate wheelchairs.

6. A double deck bus having an overall height not exceeding twelve feet six inches, said bus comprising: a lower passenger deck having a plurality of passenger seats and a passenger aisle; an upper passenger deck extending the full length of the bus having a passenger aisle positioned substantially in the center of the bus and two seat platforms, one on either side of the center aisle and plurality of passenger seats mounted to the seat platforms and wherein the passenger aisle of the upper deck depends generally downward below the seat platforms such that it invades the interior compartment of the lower deck and wherein the aisle of the upper deck is generally offset the passenger aisle of the lower deck.

7. A double deck bus comprising: a lower passenger deck having a plurality of passenger seats positioned against a wall of the bus and a passenger aisle between the seats and the second wall and a second wall of the bus; an upper passenger deck extending the full length of the bus having a passenger aisle positioned substantially in the center of the bus and a plurality of passenger seats oriented on either side of the aisle and wherein the passenger aisle of the upper deck depends generally downward both the upper deck such that it invades the interior compartment of the lower deck and wherein the aisle of the upper deck is generally offset the passenger aisle of the lower deck to maximize the head room and clearance of passengers utilizing the aisles.
